(19) United States
(12) Patent Application Publication
(10) Pub. No.: US 2007/0159762 A1
(43) Pub. Date: Jul. 12, 2007

(54) Corona discharge ionizer

(76) Inventor: Kazuo Okano, Tokyo (JP)

Correspondence Address: BIRCH STEWART KOLASCH & BIRCH, PO BOX 747, FALLS CHURCH, VA, 22040-0747, US

(21) Appl. No.: 10/587,594

(22) PCT Filed: Mar. 31, 2005
(86) PCT No.: PCT/JP05/06807

§ 371 Date: Jul. 31, 2006

(30) Foreign Application Priority Data
Apr. 5, 2004 (JP) 2004-110638

(51) Int. Cl. H02H 1/00

(52) U.S. Cl. 361/212

(57) ABSTRACT

To provide a corona discharge ionizer that makes it possible to use a piezoelectric transformer by adding an effective ion balance function with a simple structure without applying particular changes to the structure, and that realizes noise reduction.

In a corona discharge ionizer 10, a control electrode 6 is disposed in a cylindrical portion of an air supply pipe 2 which also functions as a shield body and at a location where ions are balanced. When a cylindrical inner diameter of the air supply pipe 2 is defined as Ds and an annular outer diameter of the control electrode 6 is defined as Dc, 2Dc<Ds is satisfied.

### TECHNICAL FIELD

The present invention relates to a corona discharge ionizer having an ion balance control function.

### BACKGROUND ART

In a production process of electronic devices such as semiconductors (hereinafter, simply “electronic devices”), when static electricity is generated in the electronic device, there is caused a hazard that the electronic device is electrostatically broken by high voltage static electricity, or a hazard that micro particles floating in the air attach to a semiconductor circuit to cause a short circuit of the semiconductor circuit (hereinafter, simply “electrostatic hazard”). Such hazards are serious factors which deteriorate manufacturing yield of the electronic devices.

This problem can be solved if all of floating particles in a clean room can be removed, but this is practically difficult. Hence, attempt to solve the problem is made by neutralizing the static electricity of the electronic device.

Conventionally, a corona discharge ionizer has been widely used for neutralization. Plus ions or minus ions generated by corona discharge (hereinafter, plus ions and minus ions are collectively called only “ions”) are injected such that the ions reach a subject to be neutralized, and sprayed to electronic devices which are being manufactured. At this time, air is supplied to the subject to be neutralized in some cases. Electrical charge of the electronic device and ions having a different polarity are coupled to each other to neutralize, and a hazard of the static electricity is prevented from being generated.

There are types of corona discharge ionizers, such as one using a DC power supply voltage, and one using an AC power supply voltage. In the case of the AC corona discharge ionizer, it is necessary to give particular consideration to the setting of frequency. More specifically, AC voltage having frequency lower than about 10 kHz is applied. This prevents plus ions and minus ions from re-coupling to each other. If the frequency of AC voltage is lower than about 10 kHz, for example, since plus ions generated between plus voltage are accelerated by Coulomb force and injected sufficiently afar, the plus ions are not re-coupled to minus ions which are generated later, and the neutralization ability is not varied. However, if the AC voltage becomes higher than about 10 kHz, minus ions are generated immediately after the plus ions are generated, and the plus ions are re-coupled to ions having different polarity near the plus ions, and the ion injection amount and an amount of ions reaching a subject to be neutralized are reduced. Thus, it is necessary that the AC frequency is set to a value lower than 10 kHz.

There is a tendency that the AC corona discharge ionizer generally generates more minus ions than plus ions and thus, it is necessary to control the ion balance such that the amount of the plus ions and the amount of minus ions are electrically equal to each other. In the conventional technique, offset voltage is added to the applied voltage to be supplied to an emitter, thereby equalizing the amounts of plus ions and of minus ions. Corona discharge ionizers have the above-described features.

In recent years, as the integration of the semiconductor devices is becoming higher and the devices are downsized, there is a tendency that the power supply voltage of the semiconductor device is lowered (for example, if the power supply voltage used to be 5V, it has become 3V). As a result, the semiconductor devices are easily susceptible to influence of external noise, and there is an adverse possibility that an SN ratio of the semiconductor device is lowered. Hence, for the AC corona discharge ionizer, it is considered to use a piezoelectric transformer for the AC power supply to reduce the noise.

However, since the output voltage of a piezoelectric transformer does not appear on the output side even if offset voltage is applied on the input side, it is difficult to control the ion balance by applying offset voltage as described above. In the piezoelectric transformer AC corona discharge ionizer, another control method of ion balance is required.

The present inventors conducted researches and experiments concerning the ion balance control of the piezoelectric transformer ionizer, and have disclosed a research paper of the consideration concerning this point in non-patent document 1 (Satoshi KUSAKARI and Kazuo OKANO, “Ion balance control of piezoelectric transformer ionizer”, Sep. 11, 2003, Collections of Abstracts of Annual Meeting of The Institute of Electrostatics Japan, 2003).

As explained above, in the piezoelectric transformer ionizer, it is required to reduce noise. On top of that, if its structure is less expensive, it is more preferable.

The present invention has been achieved to solve the above problem, and it is an object of the invention to make is possible to use a piezoelectric transformer by adding an effective ion balance function with a simple structure without applying particular changes to the structure, and to provide a corona discharge ionizer in which noise reduction is realized.

### DISCLOSURE OF THE INVENTION

To solve the above problem, the invention according to claim 1 provides a corona discharge ionizer which emits ions generated by corona discharge to a subject to be neutralized, comprising an emitter, a voltage supply unit which applies voltage to the emitter, an annular control electrode to which control electrode voltage is applied or which is grounded to zero potential, and a shield body formed such as to include a cylindrical portion which cover a periphery of the emitter, the control electrode is disposed in a cylindrical portion of the shield body and at a location where ions are balanced, and when a cylindrical inner diameter of the shield body is defined as Ds and an annular outer diameter of the control electrode is defined as Dc, 2Dc<Ds is satisfied.

The invention according to claim 2 provides the corona discharge ionizer of claim 1, further comprising an air supply unit which supplies air from the emitter toward the subject to be neutralized.

The invention according to claim 3 provides the corona discharge ionizer of claim 2, wherein the air supply unit includes an air supply pipe that forms a space which is covered from external other than an air supply opening from which the emitter projects, and which is grounded and which also functions as a shield body, and an air supplier in which the air supply pipe and a flow path are in communication with each other, when an interior of the air supply pipe is pressurized and air is supplied to the interior, the air supply pipe supplies air from the air supply opening toward the subject to be neutralized, and an electric field generated from the emitter by an electrostatic shield function is shut off.

The invention according to claim 4 provides the corona discharge ionizer any one of claims 1 to 3, further comprising an insulating coating portion which is coated by the emitter such as to cover in a substantially cylindrical form, and an annular inner peripheral surface of the control electrode is disposed such that the annular inner peripheral surface is in contact with the insulating coating portion.

The invention according to claim 5 provides the corona discharge ionizer of any one of claims 1 to 3, wherein the emitter is a hollow pipe and is formed at its tip end with a nozzle, and gas is injected from the nozzle.

The invention according to claim 6 provides the corona discharge ionizer of claim 4, wherein the emitter is a hollow pipe and is formed at its tip end with a nozzle, and gas is injected from the nozzle.

The present invention described above can make it possible to use a piezoelectric transformer by adding an effective ion balance function with a simple structure without applying particular changes to the structure, and can provide a corona discharge ionizer that realizes noise reduction.

### BRIEF DESCRIPTION OF THE DRAWINGS

FIG. 1 is a block diagram of a corona discharge ionizer according to a best mode for carrying out the invention.

FIG. 2 is an explanatory diagram of relevant parts of the corona discharge ionizer in which a position of a control electrode is changed.

FIG. 3 is an explanatory diagram of relevant parts of the corona discharge ionizer in which the position of the control electrode is changed.

FIG. 4 is a characteristic diagram of control electrode voltage—ion balance voltage using the position of the control electrode as a parameter.

FIG. 5 is an explanatory diagram of relevant parts of the corona discharge ionizer in which an inner diameter of the control electrode is changed.

FIG. 6 is an explanatory diagram of relevant parts of the corona discharge ionizer in which an inner diameter of the control electrode is changed.

FIG. 7 is a block diagram of a corona discharge ionizer according to another embodiment of the present invention.

FIG. 8 is a block diagram of a corona discharge ionizer according to another embodiment of the present invention.

### BEST MODE FOR CARRYING OUT THE INVENTION

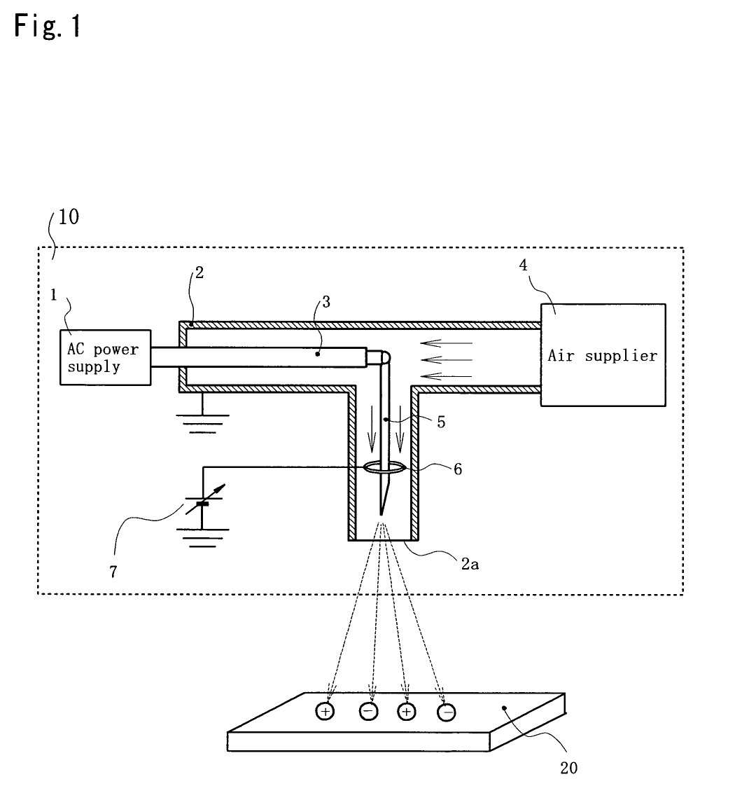

Best modes for carrying out the invention will be explained below based on the drawings. FIG. 1 is a block diagram of a corona discharge ionizer 10 according to an embodiment.

As shown in FIG. 1, the corona discharge ionizer 10 of the embodiment includes an AC power supply 1, an air supply pipe 2, a voltage supply line 3, an air supplier 4, an emitter 5, a control electrode 6, and a variable voltage supply unit 7. The corona discharge ionizer 10 sprays ions to a subject to be neutralized 20 to neutralize.

The AC power supply 1 is a voltage supply unit and applies high voltage to the emitter 5. The AC power supply 1 includes a piezoelectric transformer (not shown) to reduce noise.

The air supply pipe 2 injects compressed air supplied from the air supplier 4 under pressure from an air supply opening 2a. The air supply pipe 2 is formed such as to include a cylindrical portion covering around the emitter 5 (this cylindrical portion is a cylinder extending vertically in FIG. 1). The air supply pipe 2 is grounded and its potential is zero. The air supply pipe 2 has a function as a shield body which shields an electric field generated from the emitter 5.

The voltage supply line 3 applies AC voltage from the AC power supply 1 to the emitter 5.

The air supplier 4 is a compressor or a fan, and pressurizes an interior of the air supply pipe 2. These air supply pipe 2 and the air supplier 4 form an air supply unit for supplying air from the emitter 5 toward the subject to be neutralized 20.

A tip end of the emitter 5 is tapered. Alternatively, the emitter 5 can be of a simple rod having no tapered tip end.

The control electrode 6 is formed into an annular shape, and control electrode voltage is applied to the control electrode 6 from the variable voltage supply unit 7. The control electrode 6 forms a high piezoelectric field between the control electrode 6 and the emitter 5 to which high voltage is applied.

To supply control electrode voltage for optimizing the ion balance, the variable voltage supply unit 7 can adjust the voltage.

The subject to be neutralized 20 is an electronic device flowing on a manufacturing line in a manufacturing factory of the electronic devices, and the subject to be neutralized 20 is positively or negatively charged. This tendency is ascribable to, for example, manufacturing apparatuses or machines of a manufacturing line.

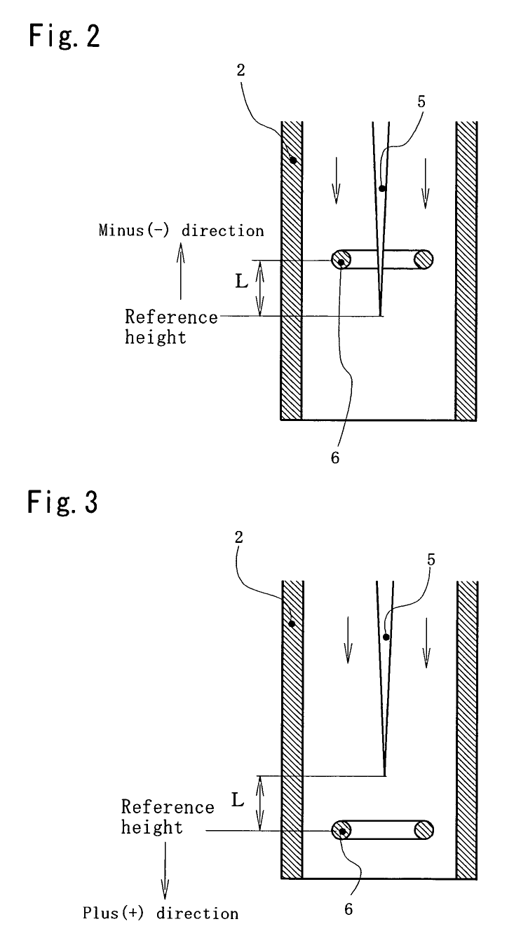

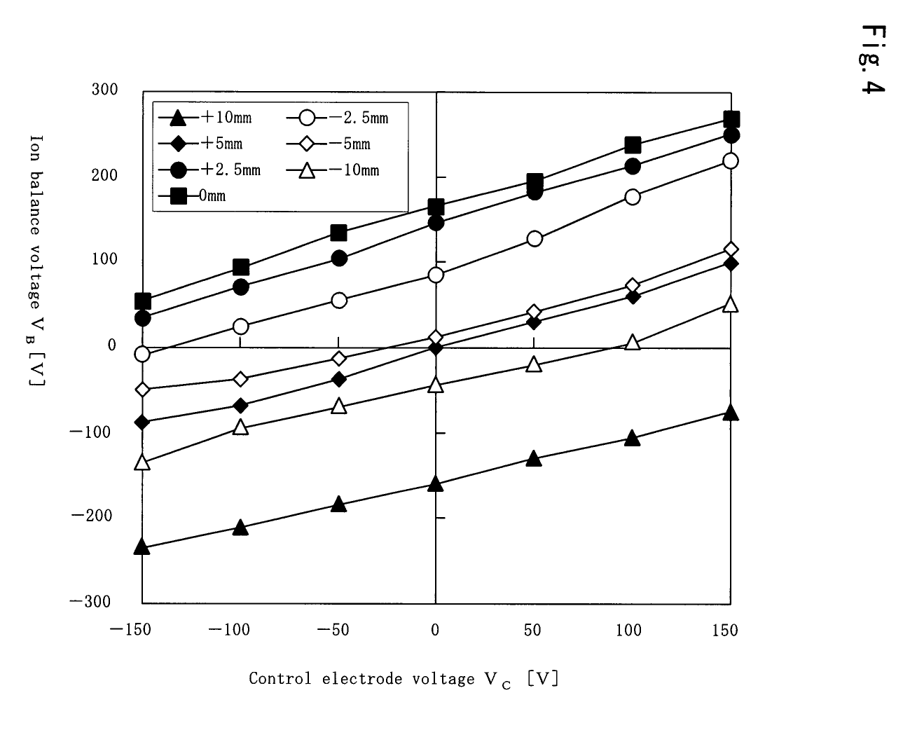

Next, an outline of the ion balance control will be explained. The present inventors conducted researches and experiments, and found that the ion balance could be controlled by varying a vertical position of the control electrode 6 based on the tip end height of the emitter 5 as a reference height instead of controlling the ion balance by adjusting the offset voltage. Such an ion balance control will be explained with reference to the drawings. FIGS. 2 and 3 are explanatory diagrams of relevant parts of the corona discharge ionizer in which the position of the control electrode 6 is changed. FIG. 4 is a characteristic diagram of the control electrode voltage—ion balance voltage using the position of the control electrode 6 as a parameter.

According to the characteristics shown in FIG. 4, in the corona discharge ionizer 10 shown in FIG. 1, an ion balance voltage measuring device (for example, a charged plate monitor: CPM) is disposed in an ion injection direction (downward in FIGS. 1 to 3) by the emitter 5 instead of the subject to be neutralized 20, the control electrode voltage is varied, and the ion balance voltage measuring device measures the ion balance voltage (as the number of plus ions is higher, the voltage becomes plus, and if the number of minus ions is higher, the voltage becomes minus). In this case, the position of the control electrode is varied as the parameter. For example, as shown in FIG. 2, a direction in which the control electrode 6 moves toward the emitter 5 from the reference height (0) of the tip end of the emitter 5 (upward direction in FIG. 2) is a minus direction (L<0), and a direction in which the control electrode 6 moves toward the air supply opening 2a from the reference height (0) of the tip end of the emitter 5 (downward direction in FIG. 3) is a plus direction (L>0).

As shown in FIG. 4, the characteristics show a tendency that the ion balance voltage is varied as the position of the control electrode 6 is varied. For example, the number of positions having a proportional relation in which both the control electrode voltage and ion balance voltage becomes substantially 0 is two (L+5 mm).

When L is equal to −5, i.e., as shown in FIG. 2, this position is a position where the emitter 5 penetrates the control electrode 6, the ion balance voltage becomes 0 (i.e., the amount of plus ions is equal to the amount of minus ions), and the ions are balanced.

It is considered that this is because minus ions having a higher moving degree than that of the plus ions are attracted to the control electrode 6 with higher priority and the ions are balanced.

Similarly, when L is equal to +5 mm, i.e., as shown in FIG. 3, in a state where the control electrode 6 is located away from a lower side of the emitter 5, the ion balance voltage is 0 (i.e., the amount of plus ions is equal to the amount of minus ions), and the ions are balanced.

It is considered that this is because the ratio of the plus ions and minus ions attracted by the control electrode 6 depends on the position and the voltage applied to the control electrode 6. However, especially in this position, when the control electrode voltage is 0V, the ion balance is controlled.

The value of L varies due to influence of the structure of an experiment apparatus and a diameter of the control electrode 6, but as explained above, the ion balance voltage becomes 0 due to −L mm (position where the emitter 5 penetrates the control electrode 6) and +L mm (position where the control electrode 6 is separated away from the emitter 5), and the ion balance can be controlled.

Usually, it is necessary to adjust the control electrode voltage such that the ion balance voltage becomes 0. However, when the control electrode is disposed at a position where both the control electrode voltage and ion balance voltage become 0, the adjustment function of the control electrode voltage becomes unnecessary, and the control electrode 6 may be grounded at that position.

The number of locations where the ions are balanced is two (+L mm), however, since it is easy to form the electric field, −L mm (position where the emitter 5 penetrates the control electrode 6) is more preferable.

An outline of the operation of the corona discharge ionizer 10 based on such a principle will be explained.

The interior of the air supply pipe 2 is pressurized by the air supplier 4 and air is supplied from the air supply opening 2a. Gas supplied from the air supply opening 2a is non-reactive gas or air. Under such circumstances, if high AC voltage is applied to the emitter 5 from the AC power supply 1 through the voltage supply line 3, the peripheries of the emitter 5 are brought into plasma state by the corona discharge, plus ions and electron are generated by gas molecule of air or non-reactive gas, electrons adhere other molecule to generate minus ions. It is assumed that the position of the control electrode 6 and the control electrode voltage are previously adjusted to a position where ions are balanced.

If plus high voltage is applied first, the generated plus ions are injected by Coulomb force received from a plus electric field and then, if minus high voltage is applied, the generated minus ions are injected by Coulomb force received from a minus electric field. In the corona discharge ionizer 10, the plus ions and minus ions are alternately generated in this manner, plus ions and minus ions having excellent ion balance are emitted to the subject to be neutralized 20, and the subject to be neutralized 20 is neutralized.

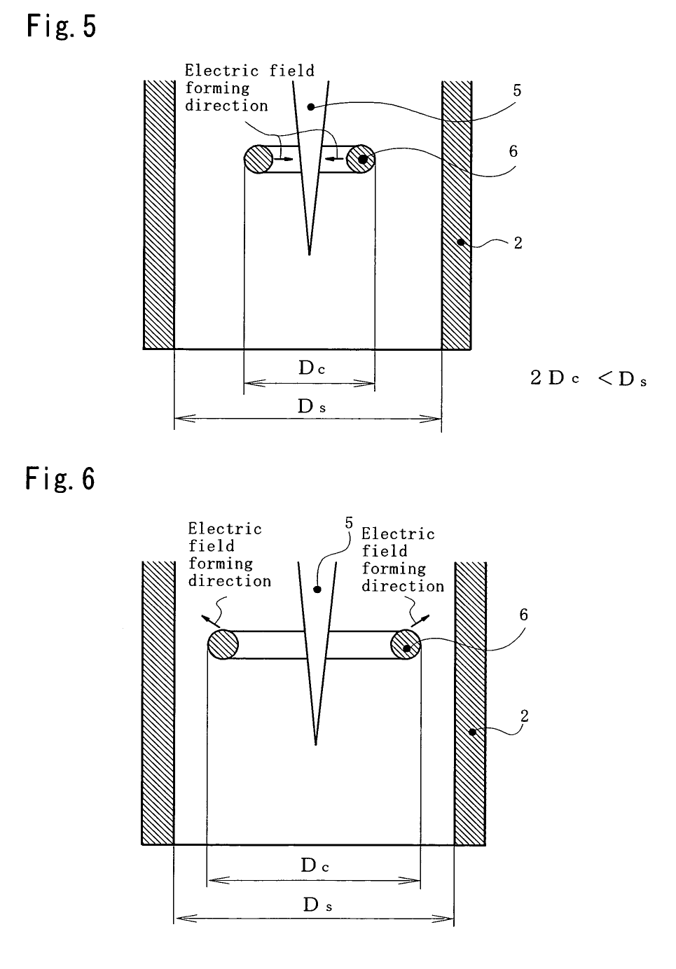

In this embodiment, a pipe inner diameter of the air supply pipe 2 which also functions as a shield body is defined as Ds and an annular outer diameter of the control electrode 6 is defined as Dc, it is preferable that 2Dc<Ds is satisfied. This point will be explained. FIGS. 5 and 6 are explanatory diagrams of relevant parts of the corona discharge ionizer in which the inner diameter of the control electrode is varied.

As shown in FIG. 6, when the annular outer diameter of the control electrode 6 is large, a pipe inner periphery of the air supply pipe 2 which is grounded and which also functions as a shield body and an annular outer periphery of the control electrode 6 are close to each other, and an electric field is adversely formed, and there is a problem that the electric field cannot be formed by the emitter 5 and the control electrode 6 and ions cannot be generated.

Hence, the annular outer diameter of the control electrode 6 is sufficiently reduced, the and pipe inner periphery of the air supply pipe 2 and the annular outer periphery of the control electrode 6 are sufficiently separated away from each other as shown in FIG. 5 so that the electric field can reliably be formed by the emitter 5 and the control electrode 6.

As shown in FIG. 5, the present inventors examined a condition in which the electric field was not formed by the pipe inner periphery of the air supply pipe 2 and the annular outer periphery of the control electrode 6 and an electric field was reliably formed by the emitter 5 and the control electrode 6, and when the pipe inner diameter of the air supply pipe 2 which also functioned as the shield body was defined as Ds and the annular outer diameter of the control electrode 6 was defined as Dc, if at least 2Dc<Ds was satisfied, it was found that the electric field was reliably formed by the emitter 5 and the control electrode 6.

The ion balance can be controlled and a sufficient amount of ions can reliably be generated by a corona discharge ionizer 10 which satisfies this condition.

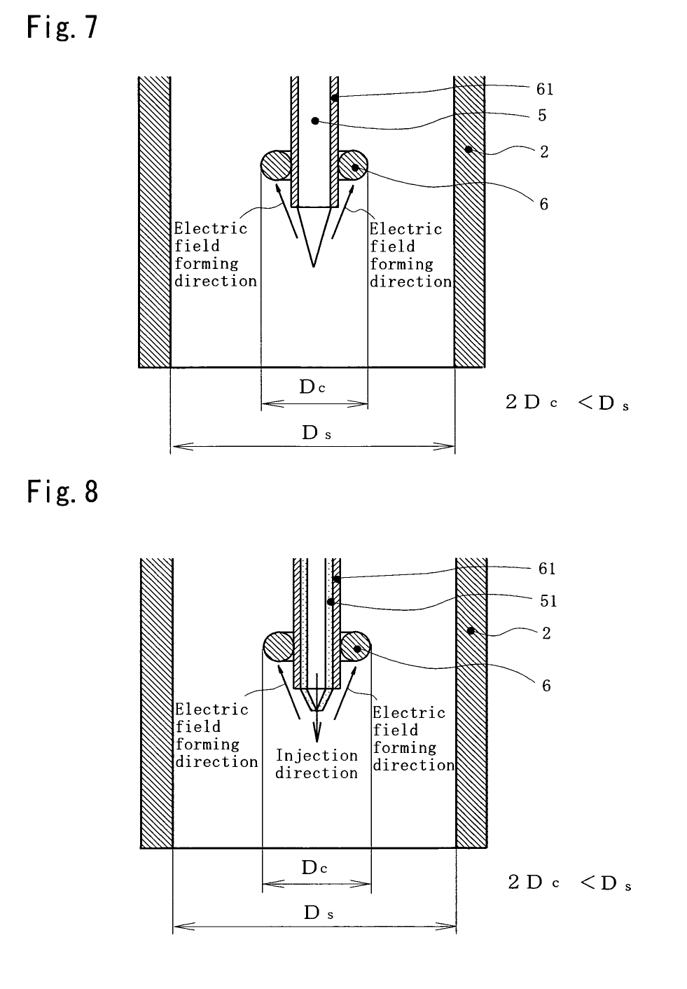

Next, other embodiments will be explained with reference to the drawing. FIG. 7 shows a structure of a corona discharge ionizer according to another embodiment. As shown in FIG. 7, only the tapered portion of the emitter 5 is exposed, and portions of the emitter 5 other than the tapered portion are coated by a substantially cylindrical insulating coating portion 61 and electrically insulated. An annular inner peripheral surface of the control electrode 6 is disposed such that the annular inner peripheral surface is in contact with an outer peripheral surface of the insulating coating portion 61. Preferably, the control electrode 6 and the insulating coating portion 61 are totally in contact with each other without creating a gap therebetween so that the discharge is prevented from being generated.

In this embodiment, an outer peripheral surface of the emitter 5 and an annular inner peripheral surface of the control electrode 6 can be brought close to each other as close as possible, and the electric field can reliably be formed by the emitter 5 and the control electrode 6.

If there exists no insulating coating portion 61, and if the outer peripheral surface of the emitter 5 and the control electrode 6 are too close to each other, there is apprehension that the emitter 5 and the control electrode 6 deteriorated or contaminated due to high voltage discharge, but if the insulating coating portion 61 is interposed therebetween as in this embodiment, since no discharge is generated, deterioration and contamination can be suppressed.

Next, another embodiment will be explained with reference to the drawing. FIG. 8 shows a structure of a corona discharge ionizer according to another embodiment. In this embodiment, the emitter is a hollow pipe as shown in FIG. 8, and the emitter is formed at its tip end with a nozzle, a tapered portion of the pipe emitter 51 from which air is injected is exposed, and portions of the emitter 51 other than the tapered portion is coated with the insulating coating portion 61 so that it is electrically insulated. An annular inner peripheral surface of the control electrode 6 is disposed in a state where the annular inner peripheral surface is in contact with an outer periphery of the substantially cylindrical insulating coating portion 61. Preferably, the control electrode 6 and the insulating coating portion 61 are totally in contact with each other without creating a gap therebetween so that the discharge is prevented from being generated.

In this embodiment, an outer peripheral surface of the emitter 5 and an annular inner peripheral surface of the control electrode 6 can be brought close to each other as close as possible, and the electric field can reliably be formed by the emitter 5 and the control electrode 6.

In this embodiment, the insulating coating portion 61 is interposed so that discharge is not generated, and deterioration and contamination can be suppressed.

Air is allowed to pass through a thin nozzle so that the air injection speed is increased, and ions can reliably reach the subject to be neutralized 20.

While the corona discharge ionizer according to the present invention has been explained above, various modifications can be made in the invention. For example, in FIG. 1, air is supplied by the air supply unit of the air supply pipe 2 and the air supplier 4, but ions are injected by Coulomb force even if air is not supplied. Thus, the air supplier 4 can be eliminated, and the emitter 5 can be simply disposed in a pipe.

In the corona discharge ionizer shown in FIG. 5, the pipe emitter 51 shown in FIG. 8 can be replaced by the emitter 5 shown in FIG. 5. In this case also, air is allowed to pass through a thin nozzle so that the air injection speed is increased, and ions can reliably reach the subject to be neutralized.

In the corona discharge ionizers 10 according to the embodiment described above, since the ion balance control can be made without using offset voltage, a piezoelectric transformer that cannot utilize the offset voltage can be used, and noise reduction can be realized.

1. A corona discharge ionizer which emits ions generated by corona discharge to a subject to be neutralized, comprising:
an emitter;
a voltage supply unit which applies voltage to the emitter;
an annular control electrode to which control electrode voltage is applied or which is grounded to zero potential; and
a shield body formed such as to include a cylindrical portion which cover a periphery of the emitter, wherein
the control electrode is disposed in a cylindrical portion of the shield body and at a location where ions are balanced, and when a cylindrical inner diameter of the shield body is defined as Ds and an annular outer diameter of the control electrode is defined as Dc, 2Dc<Ds is satisfied.

2. The corona discharge ionizer according to claim 1, further comprising an air supply unit which supplies air from the emitter toward the subject to be neutralized.

3. The corona discharge ionizer according to claim 2, wherein
the air supply unit includes an air supply pipe which forms a space which is covered from external other than an air supply opening from which the emitter projects, and which is grounded and which also functions as a shield body, and
an air supplier in which the air supply pipe and a flow path are in communication with each other,
when an interior of the air supply pipe is pressurized and air is supplied to the interior, the air supply pipe supplies air from the air supply opening toward the subject to be neutralized, and an electric field generated from the emitter by an electrostatic shield function is shut off.

4. The corona discharge ionizer according to any one of claims 1 to 3, further comprising an insulating coating portion which is coated by the emitter such as to cover in a substantially cylindrical form, wherein
an annular inner peripheral surface of the control electrode is disposed such that the annular inner peripheral surface is in contact with the insulating coating portion.

5. The corona discharge ionizer according to any one of claims 1 to 3, wherein
the emitter is a hollow pipe and is formed at its tip end with a nozzle, and gas is injected from the nozzle.

6. The corona discharge ionizer according to claim 4, wherein
the emitter is a hollow pipe and is formed at its tip end with a nozzle, and gas is injected from the nozzle.
